(19) United States
(12) Patent Application Publication
(10) Pub. No.: US 2015/0041452 A1
(43) Pub. Date: Feb. 12, 2015

(54) Food Plate Warming Device

(71) Applicant: Polete Buard, Tampa, FL (US)

(72) Inventor: Polete Buard, Tampa, FL (US)

(21) Appl. No.: 14/453,678

(22) Filed: Aug. 7, 2014

Related U.S. Application Data
(60) Provisional application No. 61/863,708, filed on Aug. 8, 2013.

(51) Int. Cl. A47J 36/24; A47J 27/00

(52) U.S. Cl. CPC A47J 36/2483; A47J 27/004
USPC 219/432

(57) ABSTRACT

A food plate warming device warms a plate prior to serving so that food on the plate remains heated when served and throughout a meal. The device includes a shelf coupled to a rack such that the shelf extends between lateral sides of the shelf. Electrical contacts are coupled to the shelf. Respective heating elements extending into and through plates such that the heating element heats a surface of the plate when the heating element is actuated. The heating element of each plate is engageable to an associated pair of the electrical contacts when the plate is positioned on the shelf wherein the heating element is actuated.

### CROSS-REFERENCE TO RELATED APPLICATIONS

This application claims benefit of the provisional application 61/863,708 filed Aug. 8, 2014.

### BACKGROUND OF THE DISCLOSURE

1. Field of the Disclosure

The disclosure relates to warming devices and more particularly pertains to a new warming device for warming a plate prior to serving so that food on the plate remains heated when served and throughout a meal.

2. Summary of the Disclosure

An embodiment of the disclosure meets the needs presented above by generally comprising a shelf coupled to a rack such that the shelf extends between lateral sides of the shelf. Electrical contacts are coupled to the shelf. Respective heating elements extending into and through plates such that the heating element heats a surface of the plate when the heating element is actuated. The heating element of each plate is engageable to an associated pair of the electrical contacts when the plate is positioned on the shelf wherein the heating element is actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a food plate warming device according to an embodiment of the disclosure.

FIG. 2 is a partial cut-away front view of an embodiment of the disclosure.

FIG. 3 is a partial cut-away top front side perspective view of an embodiment of the disclosure.

FIG. 4 is a cross-sectional view of an embodiment of the disclosure taken along line 4-4 of FIG. 2.

FIG. 5 is a cross-sectional view of an embodiment of the disclosure taken along line 5-5 of FIG. 2.

FIG. 6 is a top front side perspective view of an embodiment of the disclosure.

### DESCRIPTION OF THE PREFERRED EMBODIMENT

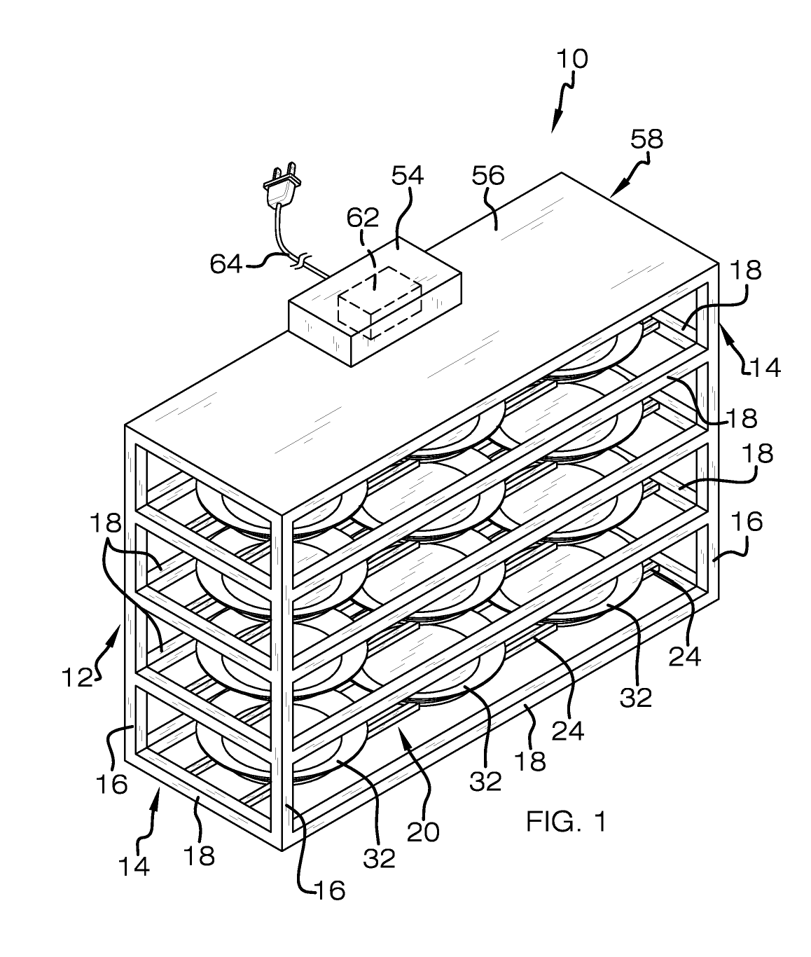

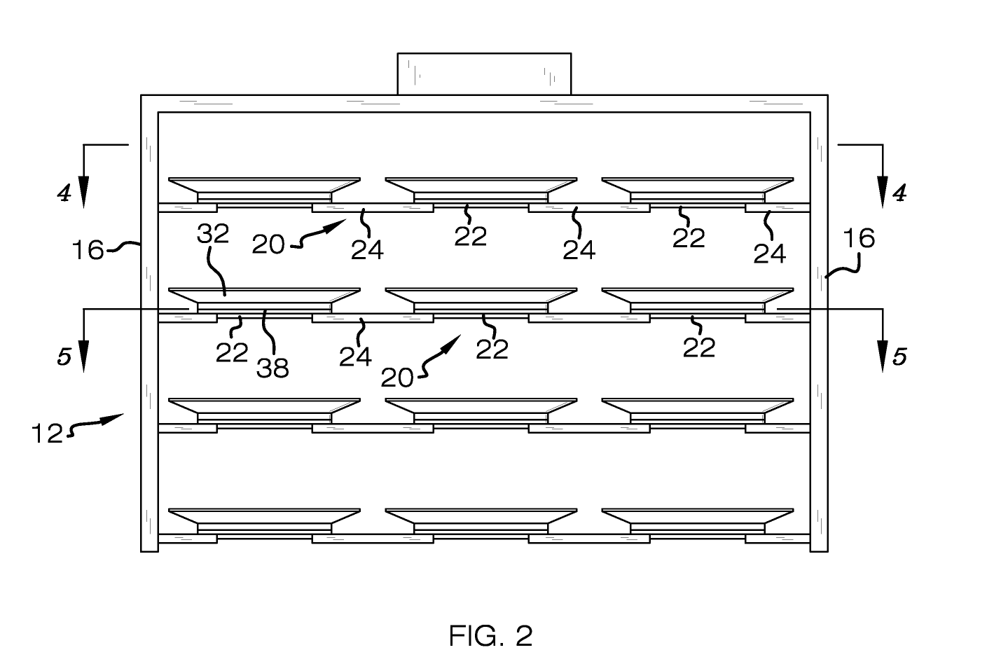

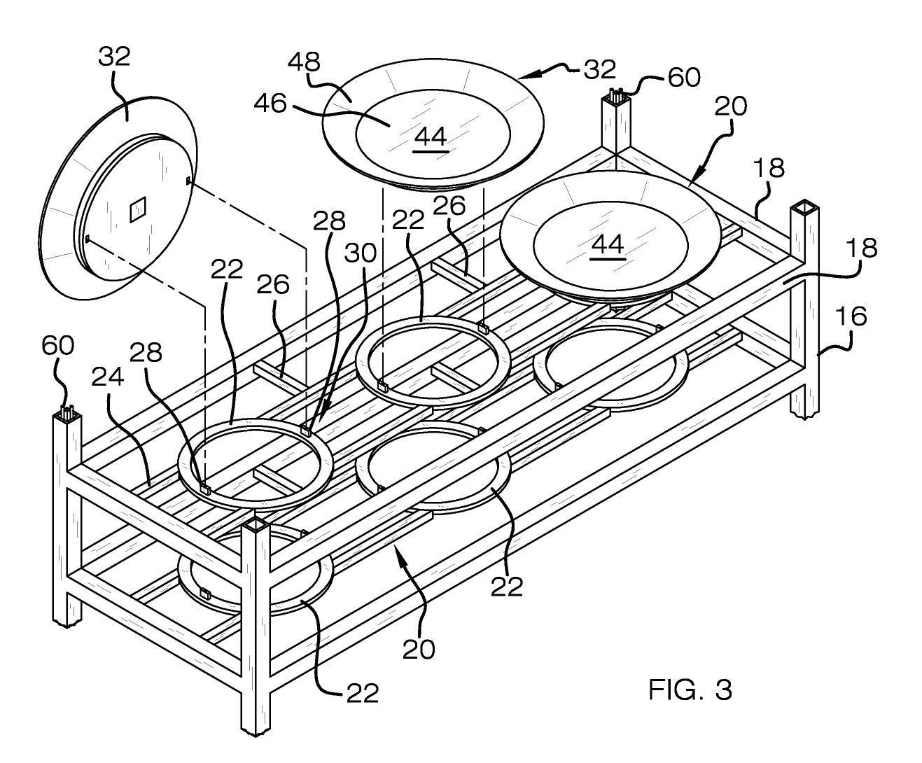

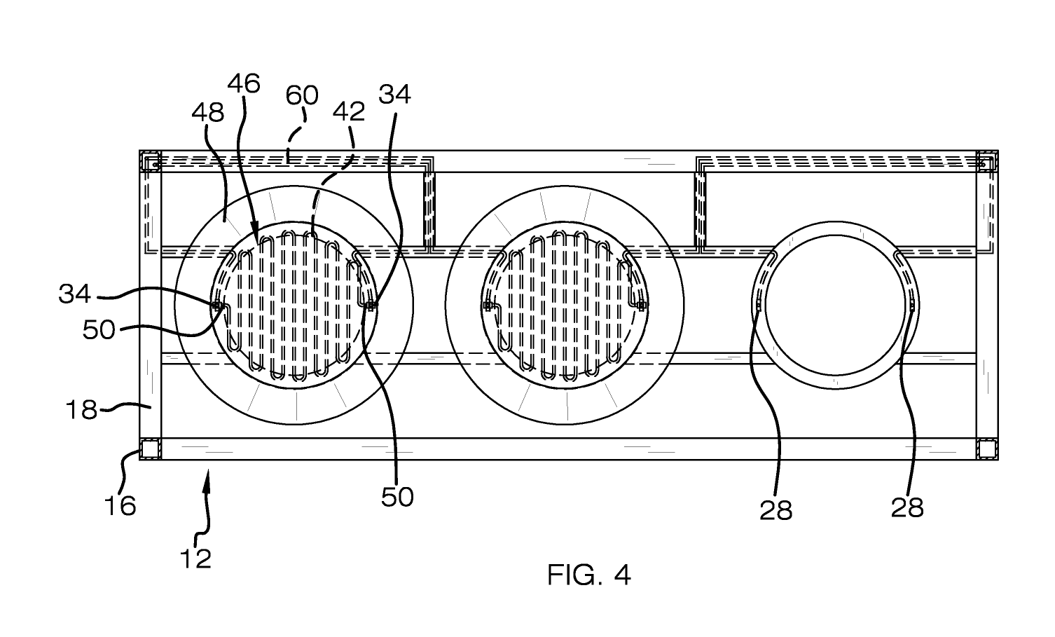

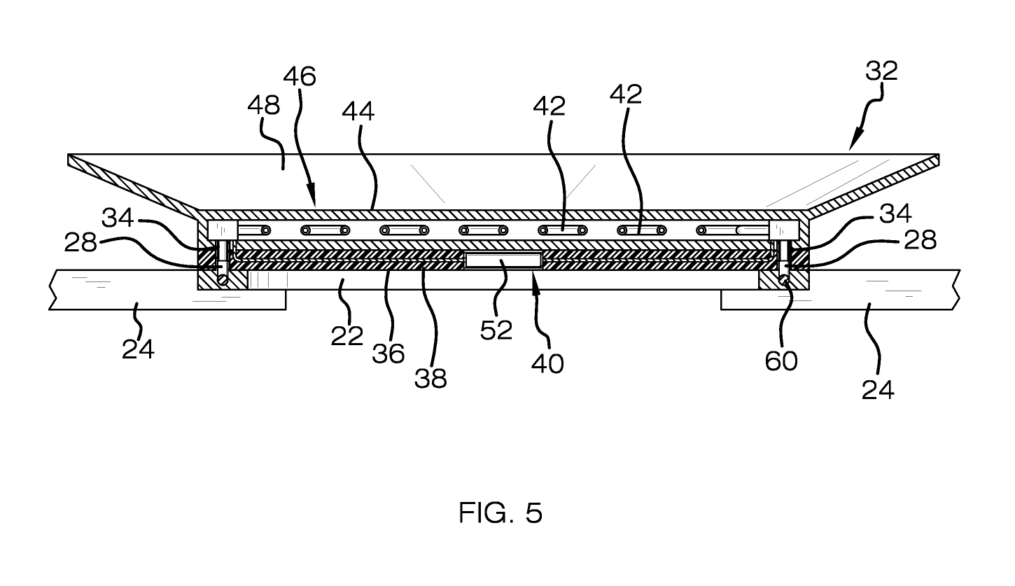

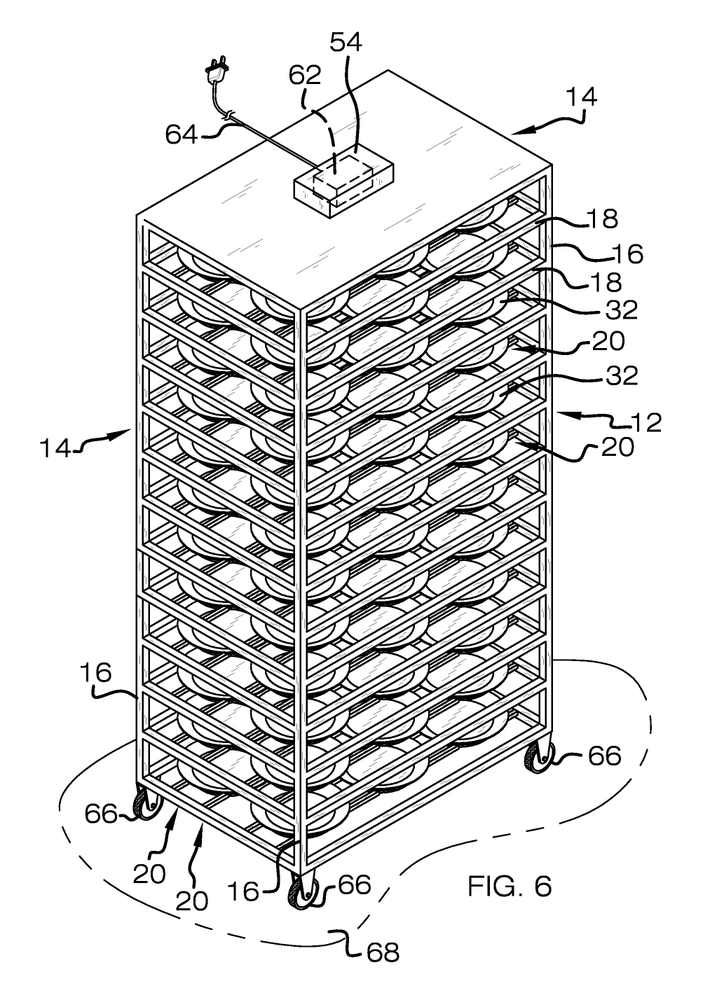

With reference now to the drawings, and in particular to FIGS. 1 through 6 thereof, a new warming device embodying the principles and concepts of an embodiment of the disclosure and generally designated by the reference numeral 10 will be described.

As best illustrated in FIGS. 1 through 6, the food plate warming device 10 generally comprises a rack 12 having a pair of lateral sides 14. The rack 12 comprises a plurality of corner rails 16 and a plurality of outer rails 18. Each of a plurality of shelves 20 is coupled to the rack 12. Each shelf 20 extends between the lateral sides 14 of the rack 12. Each shelf 20 comprises a plurality of rings 22. The rings 22 are coupled together and to the rack 12 by a plurality of interior rails 24. Each of the outer rails 18 is coplanar with an associated one of the shelves 20. The shelves 20 are vertically spaced to provide access to each shelf 20 between the lateral sides 14 of the rack 12. Each of a plurality of braces 26 extends between an associated one of the interior rails 24 and an associated one of the outer rails 18. The braces 26 may be only extend from the shelves 20 to the outer rail 18 at a back of the rack 12.

Each of a plurality of electrical contacts 28 is coupled to the shelves 20. The electrical contacts 28 are arranged into pairs 30 with each pair 30 of electrical contacts 28 being coupled to and extending from an associated one of the rings 22. Each of a plurality of plates 32 is positionable on a selectable one of the shelves 20. Each plate 32 is structured to comprise a pair of receivers 34 extending into a bottom surface 36 of the plate 32. Each plate 32 has a rubber base 38 a circular planar bottom surface 40 corresponding to a size of each ring 22. Each of the plates 32 is positionable on an associated one of the rings 22.

Each of a plurality of heating elements 42 is coupled to and extends into and through an associated one of the plates 32 such that the heating element 42 heats a surface 44 of the plate 32 when the heating element 42 is actuated. The surface 44 of the plate 32 may be a flat central section 46 surrounded by an upwardly angled flange 48. The heating element 42 may have a circuitous path corresponding to the central section 46 leaving the flange 48 unheated to facilitate serving of each plate 32 without burning a server's hands and inhibiting inadvertent contact between a heated surface and a person dining from the plate 32. The heating element 42 of each plate 32 is engageable to an associated pair 30 of the electrical contacts 28 when the plate 32 is positioned on the shelf 20 wherein the heating element 42 is actuated. Each of a pair of ends 50 of the heating element 42 is inset into one of the receivers 34 of the associated plate 32 such that the electrical contacts 28 of the associated ring 22 are electrically coupled to the heating element 42 when the plate 32 is rested upon the associated ring 22.

Each of a plurality of batteries 52 is coupled to an associated one of the heating elements 42 within each plate 32 wherein the battery 52 is charged when the electrical contacts 28 are electrically coupled to the associated heating element 42. Each battery 52 actuates the associated heating element 42 while there is a charge in the battery 52 wherein each plate 32 remains heated by the associated heating element 42 for a period of time after the plate 32 is removed from the one of the shelves 20. A power source 54 is coupled to the rack 12. The power source 54 may be positioned on a cover 56 at a top 58 of the rack 12. The power source 54 is electrically coupled to each of the electrical contacts 28 by wiring 60 extending through the rack 12. The power source 54 may be a cord 64 for direct connection to an electrical outlet or may incorporate a main battery 62 to enhance portability of the rack 12. A plurality of wheels 66 may be coupled to the rack 12 wherein the rack 12 is configured to be rolled on a supporting surface 68 allowing serving of plates directly at a table in a large banquet hall or the like.

In use, food is placed onto the plates 32. The plates 32 are positioned on the rings 22 actuating the heating elements 42 to keep the food warm. Power is supplied to the heating elements 42 through the electrical contacts 28 until the plate 32 is removed from the shelf 20. The battery 52 within the plate 32 maintains actuation of the heating element 42 for a period of time after the plate 32 is removed from the ring 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food plate warming device comprising:
a rack having a pair of lateral sides;
a shelf coupled to said rack, said shelf extending between said lateral sides of said shelf;
a plurality of electrical contacts, each of said electrical contacts being coupled to said shelf;
a plurality of plates, each of said plates being positionable on said shelf; and
a plurality of heating elements, each of said heating elements being coupled to and extending into and through an associated one of said plates such that said heating element heats a surface of said plate when said heating element is actuated, said heating element of each said plate being engageable to an associated pair of said electrical contacts when said plate is positioned on said shelf wherein said heating element is actuated.

2. The device of claim 1, further comprising said shelf comprising a plurality of rings, said rings being coupled together and to said rack by a plurality of interior rails, each of said plates being positionable on an associated one of said rings.

3. The device of claim 2, further comprising said electrical contacts being arranged into pairs, each said pair of electrical contacts being coupled to and extending from an associated one of said rings.

4. The device of claim 3, further comprising:
said pair of electrical contacts extending upwardly from said associated ring;
said plate being structured to comprise a pair of receivers extending into a bottom surface of said plate; and
each of a pair of ends of said heating element being inset into a said receivers of said associated plate such that said electrical contacts of said associated ring are electrically coupled to said heating element when said plate is rested upon said associated ring.

5. The device of claim 1, further comprising each said plate having a rubber base.

6. The device of claim 1, further comprising a plurality of batteries, each said battery being coupled to an associated one of said heating elements wherein said battery is charged when said electrical contacts are electrically coupled to said associated heating element, each said battery actuating said associated heating element wherein each said plate remains heated by said associated heating element for a period of time after said plate is removed from said shelf.

7. The device of claim 1, further comprising said rack comprising a plurality of corner rails and a plurality of outer rails, each of said outer rails being coplanar with said shelf.

8. The device of claim 7, further comprising a plurality of braces, each of said braces extending between an associated one of said interior rails and an associated one of said outer rails.

9. The device of claim 1, further comprising a power source coupled to said rack, said power source being electrically coupled to each of said electrical contacts.

10. The device of claim 9, further comprising a plurality of wheels being coupled to said rack wherein said rack is configured to be rolled on a supporting surface.

11. A food plate warming device comprising:
a rack having a pair of lateral sides, said rack comprising a plurality of corner rails and a plurality of outer rails;
a plurality of shelves coupled to said rack, each said shelf being coupled to said rack, each said shelf extending between said lateral sides of said rack, each said shelf comprising a plurality of rings, said rings being coupled together and to said rack by a plurality of interior rails, each of said outer rails being coplanar with an associated one of said shelves;
a plurality of braces, each of said braces extending between an associated one of said interior rails and an associated one of said outer rails;
a plurality of electrical contacts, each of said electrical contacts being coupled to said shelf, said electrical contacts being arranged into pairs, each said pair of electrical contacts being coupled to and extending from an associated one of said rings;
a plurality of plates, each of said plates being positionable on a selectable one of said shelves, said plate being structured to comprise a pair of receivers extending into a bottom surface of said plate, each said plate having a rubber base, said rubber base having a circular planar bottom surface corresponding to a size of each said ring, each of said plates being positionable on an associated one of said rings;
a plurality of heating elements, each of said heating elements being coupled to and extending into and through an associated one of said plates such that said heating element heats a surface of said plate when said heating element is actuated, said heating element of each said plate being engageable to an associated pair of said electrical contacts when said plate is positioned on said shelf wherein said heating element is actuated, each of a pair of ends of said heating element being inset into a said receivers of said associated plate such that said electrical contacts of said associated ring are electrically coupled to said heating element when said plate is rested upon said associated ring;
a plurality of batteries, each said battery being coupled to an associated one of said heating elements wherein said battery is charged when said electrical contacts are electrically coupled to said associated heating element, each said battery actuating said associated heating element wherein each said plate remains heated by said associated heating element for a period of time after said plate is removed from said one of said shelves; and
a power source coupled to said rack, said power source being electrically coupled to each of said electrical contacts.

12. The device of claim 11, further comprising a plurality of wheels being coupled to said rack wherein said rack is configured to be rolled on a supporting surface.
